(19) United States
(12) Patent Application Publication
(10) Pub. No.: US 2003/0056388 A1
(43) Pub. Date: Mar. 27, 2003

(54) Cleaning gas for semiconductor production equipment

(76) Inventors: Hiromoto Ohno, Kanagawa (JP); Toshio Ohi, Kanagawa (JP); Shuji Yoshida, Kanagawa (JP); Manabu Ohhira, Kanagawa (JP); Koutarou Tanaka, Kanagawa (JP)

Correspondence Address: SUGHRUE MION, PLLC, 2100 PENNSYLVANIA AVENUE, N.W., WASHINGTON, DC, 20037, US

(21) Appl. No.: 10/088,306

(22) PCT Filed: Jul. 17, 2001
(86) PCT No.: PCT/JP01/06164

(30) Foreign Application Priority Data
Jul. 18, 2000 (JP) 2000-217610
Dec. 27, 2000 (JP) 2000-397269
Jun. 22, 2001 (JP) 2001-189388

(51) Int. Cl. F26B 19/00

(52) U.S. Cl. 34/72; 34/60

(57) ABSTRACT

The present invention relates to (1) a cleaning gas for cleaning semiconductor production equipment, obtained by mixing SF₆ and one or both of F₂ with and NF₃ with an inert gas at a specific ratio; (2) a cleaning gas for cleaning semiconductor production equipment, obtained by mixing SF₆ and one or both of F₂ and NF₃ with an inert gas and an oxygen-containing gas at a specific ratio; (3) a method for cleaning semiconductor production equipment using the gas; and (4) a method for producing a semiconductor device including a cleaning step using the cleaning gas. By using the cleaning gas for semiconductor production equipment of the present invention which is high in the etching rate, efficient cleaning and production of semiconductor production equipment with excellent cost performance can be achieved.

### CROSS-REFERENCE TO RELATED APPLICATIONS

This application is based on the provisions of 35 U.S.C. Article 111(a) with claiming the benefit of filing dates of U.S. provisional application Serial No. 60/230,811 filed on Sep. 7, 2000 and U.S. provisional application Serial No. 60/261,265 filed on Dec. 27, 2000 under the provisions of 35 U.S.C. 111(b), pursuant to 35 U.S.C. Article 119(e) (1).

### TECHNICAL FIELD

The present invention relates a cleaning gas for semiconductor production equipment. Specifically, the present invention relates to a cleaning gas f or removing unnecessary deposits in film-forming equipment or etching equipment for the production of a semiconductor or a TFT liquid crystal device, which are accumulated at the film formation or etching of silicon, silicon nitride, silicon oxide, tungsten and the like, to a cleaning method using the cleaning gas, and also to a method for producing a semiconductor device including a cleaning step using the cleaning gas.

### BACKGROUND ART

In the film-forming equipment or etching equipment for the production of a semiconductor or a TFT liquid crystal device, the deposits accumulated at the film-formation or etching of silicon, silicon nitride, silicon oxide, tungsten and the like cause generation of particles and hinder the production of good film, therefore, these deposits must be removed on occasion.

Heretofore, the deposits in semiconductor production equipment are removed by a method of etching the deposits using a plasma excited from a fluorine-type etching gas such as NF₃, CF₄ and C₂F₆. However, the method of using NF₃ has a problem in that the NF₃ is expensive, and the method of using perfluorocarbon such as CF₄ and C₂F₆ has a problem in that the etching rate is low and the cleaning efficiency is low.

JP-A-8-60368 (the term “JP-A” as used herein means an “unexamined published Japanese patent application”) describes a method of using a cleaning gas where at least one gas of F₂, ClF₃, BrF₃ and BrF₅ is mixed in an amount of 1 to 50 volt with CF₄ or C₂F₆. Also, JP-A-10-72672 describes a method of using F₂ diluted with an inert carrier gas as the cleaning gas. However, these methods have a problem in that the etching rate is lower and the cleaning efficiency is lower than the method of using NF₃ as a cleaning gas.

JP-A-3-146681 describes a mixed gas composition for cleaning, where at least one gas of F₂, Cl₂ and a halogen fluoride is mixed in an amount of 0.05 to 20 volt with NF₃ to improve the etching rate. Also, a plasmaless cleaning method using a halogen fluoride such as ClF₃ as the cleaning gas is known. However, the halogen fluoride is very expensive and moreover, extremely highly reactive, therefore, despite the excellent cleaning efficiency, there is a problem in that the greatest possible care is necessary for the handling. Furthermore, the halogen fluoride may damage the equipment material inside the semiconductor production equipment and therefore, its use is disadvantageously limited only to some devices such as CVD device.

That is, conventionally known cleaning gases have the following problems:

(1) the gases having high cleaning efficiency are expensive; and

(2) the gases cannot be used except for some devices.

Inexpensive cleaning gases have a problem in that both the etching rate and the cleaning efficiency are low.

The present invention has been made under these circumstances. Accordingly, one of the objects of the present invention is to provide a cleaning gas and a cleaning method, which ensure high etching rate, high cleaning efficiency and excellent cost performance. One of the objects of the present invention is to provide a method for producing a semiconductor device.

### DISCLOSURE OF THE INVENTION

As a result of extensive investigations to solve the above-described problems, the present inventors have found that a cleaning gas obtained by mixing SF₆ and one or both of F₂ and NF₃ with an inert gas at a specific ratio is remarkably improved in the etching rate and elevated in the cleaning efficiency. Moreover, the present inventors have found that the cleaning efficiency is further improved by using the cleaning gas with an oxygen-containing gas contained therein in a specific ratio.

The present invention relates to a cleaning gas for cleaning semiconductor production equipment as described in (1) to (22) below, to a cleaning method as described in (23) to (32) below, and to a method for producing a semiconductor device, described in (33) and (36) below.

(1) A cleaning gas for semiconductor production equipment, which is a cleaning gas for removing deposits in the equipment, comprising an inert gas and at least two gases selected from the group consisting of SF₆, F₂, and NF₃ excluding the combination of F₂ and NF₃ alone.

(2) The cleaning gas for semiconductor production equipment as described in (1) above, comprising SF₆, F₂, and an inert gas.

(3) The cleaning gas for semiconductor production equipment as described in (1) above, comprising SF₆, NF₃, and an inert gas.

(4) The cleaning gas for semiconductor production equipment as described in (1) above, comprising SF₆, F₂, NF₃, and an inert gas.

(5) The cleaning gas for semiconductor production equipment as described in any one of (1) to (4) above, wherein the inert gas is at least one selected from the group consisting of He, Ne, Ar, Xe, Kr and N₂.

(6) The cleaning gas for semiconductor production equipment as described in (5) above, wherein the inert gas is at least one selected from the group consisting of He, Ar, and N₂.

(7) The cleaning gas for semiconductor production equipment as described in (1) above, wherein F₂ and/or NF₃ is from 0.01 to 5 and the inert gas is from 0.01 to 500 in terms of the volume ratio assuming that SF₆ is 1.

(8) The cleaning gas for semiconductor production equipment as described in (7) above, wherein F₂ and/or NF₃ is from 0.1 to 1.5 and the inert gas is from 0.1 to 30 in terms of the volume ratio assuming that SF₆ is 1.

(9) The cleaning gas for semiconductor production equipment as described in (1) above, which contains at least one gas selected from the group consisting of perfluorocarbon, hydrofluorocarbon, perfluoroether and hydrofluoroether.

(10) The cleaning gas for semiconductor production equipment as described in (9) above, wherein the perfluorocarbon and hydrofluorocarbon each has from 1 to 4 carbon atoms and the perfluoroether and hydrofluoroether each has from 2 to 4 carbon atoms.

(11) A cleaning gas for semiconductor production equipment, which is a cleaning gas for removing deposits in the equipment, comprising an oxygen-containing gas, an inert gas and at least two gases selected from the group consisting of SF₆, F₂, and NF₃ excluding the combination of F₂ and NF₃ alone.

(12) The cleaning gas for semiconductor production equipment as described in (11) above, comprising an inert gas, an oxygen-containing gas, SF₆, and F₂

(13) The cleaning gas for semiconductor production equipment as described in (11) above, comprising an oxygen-containing gas, an inert gas, SF₆, and NF₃.

(14) The cleaning gas for semiconductor production equipment as described in (11) above, comprising an oxygen-containing gas, an inert gas, SF₆, F₂ and NF₃.

(15) The cleaning gas for semiconductor production equipment as described in any one of (11) to (14) above, wherein the oxygen-containing gas is at least one selected from the group consisting of O₂, O₃, N₂O, NO, NO₂, CO and CO₂.

(16) The cleaning gas for semiconductor production equipment as described in (15) above, wherein the oxygen-containing gas is O₂ and/or N₂O.

(17) The cleaning gas for semiconductor production equipment as described in any one of (11) to (14) above, wherein the inert gas is at least one selected from the group consisting of He, Ne, Ar, Xe, Kr and N₂.

(18) The cleaning gas for semiconductor production equipment as described in (17) above, wherein the inert gas is at least one selected from the group consisting of He, Ar, and N₂.

(19) The cleaning gas for semiconductor production equipment as described in (11) above, wherein F₂ and/or NF₃ is from 0.01 to 5, the oxygen-containing gas is from 0.01 to 5 and the inert gas is from 0.01 to 500 in terms of the volume ratio assuming that SF₆ is 1.

(20) The cleaning gas for semiconductor production equipment as described in (19) above, wherein F₂ and/or NF₃ is from 0.1 to 1.5, the oxygen-containing gas is from 0.1 to 1.5 and the inert gas is from 0.1 to 30 in terms of the volume ratio assuming that SF₆ is 1.

(21) The cleaning gas for semiconductor production equipment as described in (11) above, which contains at least one gas selected from the group consisting of perfluorocarbon, hydrofluorocarbon, perfluoroether and hydrofluoroether.

(22) The cleaning gas for semiconductor production equipment as described in (21) above, wherein the perfluorocarbon and hydrofluorocarbon each has from 1 to 4 carbon atoms and the perfluoroether and hydrofluoroether each has from 2 to 4 carbon atoms.

(23) A method for cleaning semiconductor production equipment, comprising use of the cleaning gas described in any one of (1) to (10) above.

(24) The method for cleaning semiconductor production equipment as described in (23) above, wherein the cleaning gas described in any one of (1) to (10) above is excited to produce plasma and the deposits in the semiconductor production equipment are removed in the plasma.

(25) The method for cleaning semiconductor production equipment as described in (24) above, wherein the excitation source for the plasma is a microwave.

(26) The method for cleaning semiconductor production equipment as described in any one of (23) to (25) above, wherein the cleaning gas described in any one of (1) to (10) above is used at a temperature range of 50 to 500° C.

(27) The method for cleaning semiconductor production equipment as described in (23) above, wherein the cleaning gas described in any one of (1) to (10) above is used at a temperature range of 200 to 500° C. in a plasmaless system.

(28) A method for cleaning semiconductor production equipment, comprising use of the cleaning gas described in any one of (11) to (22) above.

(29) The method for cleaning semiconductor production equipment as described in (28) above, wherein the cleaning gas described in any one of (11) to (22) above is excited to produce plasma and the deposits in the semiconductor production equipment are removed in the plasma.

(30) The method for cleaning semiconductor production equipment as described in (29) above, wherein the excitation source for the plasma is a microwave

(31) The method for cleaning semiconductor production equipment as described in any one of (28) to

(30) above, wherein the cleaning gas described in any one of (11) to (22) above is used at a temperature range of 50 to 500° C.

(32) The method for cleaning semiconductor production equipment as described in (28) above, wherein the cleaning gas described in any one of (11) to (22) above is used at a temperature range of 200 to 500° C. in a plasmaless system.

(33) A method for producing a semiconductor device, comprising a cleaning step of using a cleaning gas containing an inert gas and at least two gases selected from the group consisting of SF₆, F₂ and NF₃ excluding the combination of F₂ and NF₃ alone, and a decomposition step of decomposing a fluorocompound-containing gas discharged from the cleaning step.

(34) The method for producing a semiconductor device as described in (33) above, wherein the fluorocompound is at least one compound selected from the group consisting of HF, SiF₄, SF₆, SF₄, SOF₂, SO₂F₂, and WF₆.

(35) A method for producing a semiconductor device, comprising a cleaning step of using a cleaning gas containing an inert gas, an oxygen-containing gas and at least two gases selected from the group consisting of SF₆, F₂ and NF₃ excluding the combination of F₂ and NF₃ alone, and a decomposition step of decomposing a fluorocompound-containing gas discharged from the cleaning step.

(36) The method for producing a semiconductor device as described in (35) above, wherein the fluorocompound is at least one compound selected from the group consisting of HF, SiF₄, SF₆, SF₄, SOF₂, SO₂F₂, and WF₆.

### BRIEF DESCRIPTION OF DRAWING

FIG. 1 is a schematic view of etching equipment using the cleaning gas of the present invention.

### DETAILED DESCRIPTION OF THE INVENTION

The present invention provides “a cleaning gas for semiconductor production equipment, which is a cleaning gas for removing deposits in semiconductor production equipment, comprising an inert gas, SF₆ and one or both of F₂ and NF₃” (the invention of the first cleaning gas), “a cleaning gas for semiconductor production equipment, which is a cleaning gas for removing deposits in semiconductor production equipment, comprising an inert gas, an oxygen-containing gas, SF₆ and one or both of F₂ and NF₃” (the invention of the second cleaning gas), “a method for cleaning semiconductor production equipment, comprising use of the above-described cleaning gas” and “a method for producing a semiconductor device, comprising a cleaning step of using the above cleaning gas, and a decomposition step of decomposing a fluorocompound-containing gas discharged from the cleaning step”.

The present invention is described in detail below.

The first cleaning gas for semiconductor production equipment of the present invention comprises an inert gas with any one of the three combinations,

SF₆ and F₂,

SF₆ and NF₃, or

SF₆, F₂ and NF₃.

(Hereinafter, the components other than the inert gas in the cleaning gas is referred to as “active gas ”.

The inert gas is at least one gas selected from the group consisting of He, Ne, Ar, Xe, Kr and N₂. Among these, the inert gas is preferably at least one gas selected from the group consisting of He, Ar and N₂, because the cleaning gas can exhibit high etching rate and excellent cost performance.

The mixing ratio of the gas components in the cleaning gas of the present invention is not particularly limited, however, the ratio of the other gas components (NF₃, F₂ or NF₃ +F₂) is usually from 0.01 to 5, preferably from 0.1 to 1.5, and the inert gas is from 0.01 to 500, preferably from 0.1 to 300, more preferably from 0.1 to 30, in terms of the volume ratio assuming that SF₆ in the active gas components is 1. When used in production process of semiconductor production equipment or liquid crystal devices, it is preferable that the gas contains the active gas components in a large amount. However, if these gases are activated moreover in plasma on use, the equipment material in the plasma atmosphere may be damaged. On the other hand, if the amount added is too small, the effect is disadvantageously low. These gases may be mixed inside the semiconductor production equipment or in the pipeline leading to the semiconductor production equipment, or the gases may be previously mixed in a gas cylinder.

In the cleaning gas for semiconductor production equipment of the present invention, when F₂ and/or NF₃ gas capable of dissociating particularly at a low energy level and producing an active species is mixed, the effect brought out surpasses the effect by conventionally used cleaning gas or etching gas, such as CF₄ or C₂F₆. The synergistic effect by the mixing is presumed to occur because the active species produced at a low energy level acts on undissociated molecule in a chain-reaction manner and accelerates the dissociation.

The cleaning gas of the present invention may contain at least one gas selected from the group consisting of perfluorocarbon, hydrofluorocarbon, perfluoroether and hydrofluoroether, in the mixed gas comprising an inert gas, SF₆ and one or both of F₂ and NF₃ The perfluorocarbon and hydrofluorocarbon each is a compound having from 1 to 4 carbon atoms. Examples of the saturated perfluorocarbon compound include CF₄, C₂F₆ and C₃F₈, examples of the unsaturated perfluorocarbon compound include C₂F₄, C₃F₆ and C₄F₆, and examples of the hydrofluorocarbon include CHF₃ and C₂H₂F₄. The perfluoroether and hydrofluoroether each is a compound having from 2 to 4 carbon atoms. Examples of the perfluoroether include CF₃OCF₃ and CF₃OCF₂CF₃, and examples of the hydrofluoroether include CHF₂OCHF₂ and. CHF₂OCH₂CF₃. The mixing ratio of the gas such as perfluorocarbon is from 0.01 to 1, preferably from 0.01 to 0.5, more preferably from 0.01 to 0.2, in terms of the volume ratio assuming that the mixed gas comprising SF₆, F₂, NF₃ and an inert gas is 1.

The second cleaning gas for semiconductor production equipment of the present invention comprises an inert gas, an oxygen-containing gas, and any one of the three combinations,

SF₆ and F₂,

SF₆ and NF₃, or

SF₆, F₂ and NF₃.

(Hereinafter, the components, other than the inert gas and oxygen-containing gas in the cleaning gas, are referred to as “active gas”.)

The oxygen-containing gas is at least one selected from the group consisting of O₂, O₃, N₂O, NO, NO₂, CO and CO₂. Particularly, it is preferable that the oxygen-containing gas is O₂ and/or N₂O, so that the etching rate of the cleaning gas is increased and thus the cost-performance is improved.

The inert gas is at least one gas selected from the group consisting of He, Ne, Ar, Xe, Kr and N₂. Among these, the inert gas is preferably at least one gas selected from the group consisting of He, Ar and N₂, because the cleaning gas can exhibit high etching rate and excellent cost performance.

The mixing ratio of the gas components in the cleaning gas of the present invention comprising SF₆ with F₂ and/or NF₃, an oxygen-containing gas and an inert gas is not particularly limited. However, the ratio is usually such

that F₂ and/or NF₃ is usually from 0.01 to 5, preferably from 0.1 to 1.5,

that the oxygen-containing gas is from 0.01 to 5, preferably from 0.1 to 1.5, and

that the inert gas is from 0.01 to 500, preferably from 0.1 to 300, more preferably from 0.1 to 30, in terms of the volume ratio assuming that SF₆ is 1. When used for cleaning gas of manufacturing semiconductor production equipment or liquid crystal devices, the oxygen-containing gas, SF₆, F₂ and NF₃ are active, which are preferably contained in a large amount. However, if these gases are activated moreover in plasma on use, the equipment material in the plasma atmosphere may be damaged. On the other hand, if the amount added is too small, the effect is disadvantageously low. These gases may be mixed inside the semidonductor production equipment or in the pipeline leading to the semiconductor production equipment, or the gases may be previously mixed in a gas cylinder.

The cleaning gas of the present invention may contain at least one gas selected from the group consisting of perfluorocarbon, hydrofluorocarbon, perfluoroether and hydrofluoroether, in the mixed gas comprising an oxygen-containing gas, an inert gas, and SF₆ with F₂ and/or NF₃. The perfluorocarbon and hydrofluorocarbon each is a compound having from 1 to 4 carbon atoms. Examples of the saturated perfluorocarbon compound include CF₄, C₂F₆ and C₃F₈, examples of the unsaturated perfluorocarbon compound include C₂F₄, C₃F₆ and C₄F₆, and examples of the hydrofluorocarbon include CHF₃ and C₂H₂F₄. The perfluoroether and hydrofluoroether each is a compound having from 2 to 4 carbon atoms. Examples of the perfluoroether include CF₃OCF₃ and CF₃OCF₂CF₃, and examples of the hydrofluoroether include CHF₂₀CHF₂ and CHF₂OCH₂CF₃. The mixing ratio of the gas such as perfluorocarbon is from 0.01 to 1, preferably from 0.01 to 0.5, more preferably from 0.01 to 0.2, in terms of the volume ratio assuming that the mixed gas comprising an oxygen-containing gas, an inert gas, and SF₆ with F₂ and/or NF₃ is 1.

The cleaning gas for semiconductor production equipment according to the present invention, comprising an oxygen-containing gas, an inert gas, and SF₆ with F₂ and/or NF₃, can exhibit effects superior to those provided by a conventional cleaning gas such as CF₄ and C₂F₆, by containing

(1) F₂ and/or NF₃, gas which dissociates at a low energy level and produces an active species, and

(2) oxygen atoms which are effective in producing and maintaining active species.

The effect involved by containing F₂ and/or NF₃ as a component in the mixed gas is presumed to occur because the active species produced at a low energy level acts on undissociated molecule in a chain-reaction manner and accelerates the dissociation. The effect involved by containing oxygen as a component in the mixed gas is presumed to occur because the oxygen helps maintain activity of active species and prevents deactivation caused by rebinding.

In the case of cleaning semiconductor production equipment using the cleaning gas of the present invention, the gas may be used under the plasma condition or under the plasmaless condition.

When the gas is used under the plasma condition, the excitation source is not particularly limited as long as plasma is excited from the cleaning gas of the present invention, but a microwave excitation source is preferred because good cleaning efficiency can be attained. Also, the temperature and the pressure when the cleaning gas of the present invention is used are not particularly limited as long as plasma can be produced, but the temperature range is preferably from 50 to 500° C. and the pressure range is preferably from 1 to 500 Pa.

In the case of plasmaless condition, the cleaning gas is introduced into a chamber, the inner pressure of the chamber is preferably set to 1 to 67 Pa and at least a part of or either one of the inside of chamber and the cleaning gas is heated at 200 to 500° C. to generate free fluorine having reactivity from the cleaning gas. Then, deposits are etched and removed from the chamber and from other regions where deposits are accumulated, and thereby the semiconductor production equipment can be cleaned.

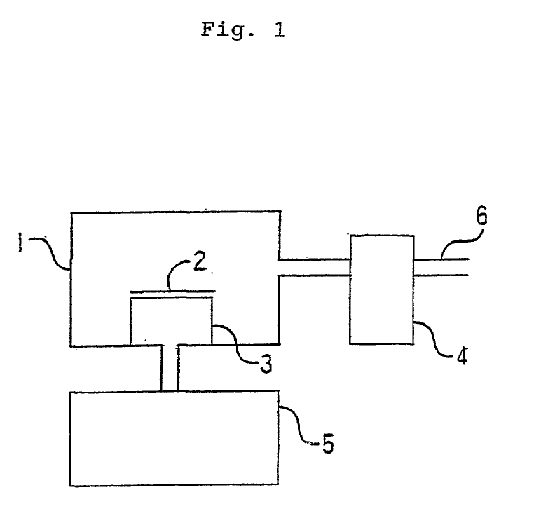

FIG. 1 is a view showing one example of the etching equipment using the cleaning gas of the present invention. The cleaning gas is introduced into a chamber 1 set at a constant temperature from a cleaning gas inlet 6 and at this time, the gas is excited by a microwave plasma excitation source 4 and produces plasma. The gas obtained after the etching of a silicon wafer 2 on sample stage 3 is discharged by a dry pump 5 and rendered harmless using a decomposing agent according to the kind of the gases contained therein. Furthermore, the deposits accumulated after the etching are efficiently removed by repeating the same operation as the etching, and thereby the chamber can be efficiently cleaned.

The method for producing a semiconductor device of the present invention is described below.

As described above, according to the present invention, the cleaning of semiconductor production equipment can be efficiently performed. However, the gas discharged from the cleaning step using the cleaning gas of the present invention contains fluorocompounds such as HF, SiF₄, SF₄, SOF₂, SO₂F₂ and WF₆, in addition to SF₆, F₂ and NF₃ used as the cleaning gas. If these compounds including SF₆, F₂ and NF₃ are discharged intact into atmosphere, they greatly affect the global warming or generate an acid gas by decomposition, therefore, each compound must be completely rendered harmless. In the method for producing a semiconductor device, the present invention provides a production method of a semiconductor device, comprising a cleaning step of cleaning semiconductor production equipment and a step of decomposing a fluorocompound-containing gas discharged from the cleaning step.

The step of cleaning semiconductor production equipment can be efficiently performed by using the method described above. The method for use in the step of decomposing the fluorocompound-containing gas discharged from the cleaning step is not particularly limited and the decomposing agent can be appropriately selected according to the kind of the compound contained in the exhaust gas. However, hydrogen fluoride, SOX and the like are preferably fixed as a fluoride or a sulfate of metal, and carbon is preferably discharged after completely decomposing it into carbon dioxide.

### BEST MODE FOR CARRYING OUT THE INVENTION

The present invention is described in greater detail below by referring to the Examples and Comparative Examples, however, the present invention is not limited to these Examples.

### EXAMPLES 1 to 3

A testing apparatus shown in FIG. 1 was adjusted to an apparatus inner pressure of 300 Pa. A cleaning gas having the composition shown in Table 1 was excited by a microwave plasma excitation source of 2.45 GHz and 500 W and then introduced into the testing apparatus to etch a silicon wafer placed in the testing apparatus. The etching rate was determined from the loss in volume of the silicon wafer after etching and the results are shown in Table 1.

TABLE 1

| | Gas Used and Mixing Ratio | | | |
|---|---|---|---|---|
| | (Volume Ratio) | | | Etching Rate |
| Example | SF₆ | F₂ | He | (nm/min) |
| 1 | 1 | 1 | 200 | 200 |
| 2 | 1 | 0.5 | 170 | 180 |
| 3 | 1 | 1.5 | 250 | 190 |

### EXAMPLES 4 to 6

A testing apparatus shown in FIG. 1 was adjusted to an apparatus inner pressure of 300 Pa. A cleaning gas having the composition shown in Table 2 was excited by a microwave plasma excitation source of 2.45 GHz and 500 W and then introduced into the testing apparatus to etch a silicon wafer placed in the testing apparatus. The etching rate was determined from the loss in volume of the silicon wafer after the etching and the results are shown in Table 2.

TABLE 2

| | Gas Used and Mixing Ratio | | | |
|---|---|---|---|---|
| | (Volume Ratio) | | | Etching Rate |
| Example | SF₆ | NF₃ | He | (nm/min) |
| 4 | 1 | 1 | 200 | 200 |
| 5 | 1 | 0.5 | 170 | 180 |
| 6 | 1 | 1.5 | 250 | 190 |

### COMPARATIVE EXAMPLES 1 to 5

The etching rate of each cleaning gas was determined in the same manner as in Examples 1 to 6 except that the cleaning gas was changed to a gas having the composition shown in Table 3.

TABLE 3

| | Gas Used and Mixing Ratio | | |
|---|---|---|---|
| Comparative | (Volume Ratio) | | Etching Rate |
| Example | Gas Used | Mixing Ratio | (nm/min) |
| 1 | NF₃/He | 1/100 | 190 |
| 2 | SF₆/He | 1/100 | 70 |
| 3 | F₂/He | 1/100 | 170 |
| 4 | CF₄/He | 1/100 | 17 |
| 5 | C₂F₆/He | 1/100 | 6 |

Among the cleaning gases mixed with He shown in Table 3, the etching rate was highest in the case of using NF₃.

### COMPARATIVE EXAMPLES 6 TO 8

The etching rate was determined in the same manner as in Examples 1 to 6 except that the cleaning gases were changed to the gases each having the composition shown in Table 4.

TABLE 4

| | Gas Used and Mixing Ratio | | | |
|---|---|---|---|---|
| Comparative | (Volume Ratio) | | | Etching Rate |
| Example | NF₃ | F₂ | He | (nm/min) |
| 6 | 1 | 1 | 200 | 175 |
| 7 | 1 | 0.5 | 170 | 170 |
| 8 | 1 | 1.5 | 250 | 170 |

All of the etching rate of the mixed gases shown in Comparative Examples 6 to 8 were lower than the rate of the cleaning gases of the present invention shown in Examples 1 to 6.

### COMPARATIVE EXAMPLES 9 TO 11

The etching rate was determined in the same manner as in Examples 1 to 6 except that the cleaning gases were changed to the gases each having the composition shown in Table 5.

TABLE 5

| | Gas Used and Mixing Ratio | | | |
|---|---|---|---|---|
| Comparative | (Volume Ratio) | | | Etching Rate |
| Example | CF₄ | F₂ | He | (nm/min) |
| 9 | 1 | 1 | 200 | 140 |
| 10 | 1 | 0.5 | 170 | 120 |
| 11 | 1 | 1.5 | 250 | 155 |

All of the etching rate of the mixed gases shown in Comparative Examples 9 to 11 were lower than the rate of the cleaning gases of the present invention shown in Examples 1 to 6.

### COMPARATIVE EXAMPLES 12 TO 14

The etching rate was determined in the same manner as in Examples 1 to 6 except that the cleaning gases were changed to the gases each having the composition shown in Table 6.

TABLE 6

| | Gas Used and Mixing Ratio | | | |
|---|---|---|---|---|
| Comparative | (Volume Ratio) | | | Etching Rate |
| Example | C₂F₆ | F₂ | He | (nm/min) |
| 12 | 1 | 1 | 200 | 50 |
| 13 | 1 | 0.5 | 170 | 30 |
| 14 | 1 | 1.5 | 250 | 100 |

All of the etching rate of the mixed gases shown in Comparative Examples 12 to 14 were lower than the rate of the cleaning gases of the present invention shown in Examples 1 to 6.

### COMPARATIVE EXAMPLE 15

The etching rate was determined in the same manner as in Examples 1 to 6 except that the cleaning gas was changed to a gas having the composition shown in Table 7.

TABLE 7

| | Gas Used and Mixing Ratio | | |
|---|---|---|---|
| Comparative | (Volume Ratio) | | Etching Rate |
| Example | Gas Used | Mixing Ratio | (nm/min) |
| 15 | NF₃/He | 1/10 | 1,900 |

It is seen that when the concentration of NF₃ was increased to ten times that of Comparative Example 1, the etching rate also became ten times higher.

### EXAMPLE 7

The etching rate of the cleaning gas of the present invention was determined in the same manner as in Examples 1 to 3 except that the cleaning gas was changed to a gas having the composition shown in Table 8.

TABLE 8

| | Gas Used and Mixing Ratio | | | |
|---|---|---|---|---|
| | (Volume Ratio) | | | Etching Rate |
| Example | SF₆ | F₂ | He | (nm/min) |
| 7 | 1 | 1 | 20 | 2,200 |

The etching rate of the cleaning gas of the present invention shown in Example 7 was more excellent than the rate of NF₃ shown in Comparative Example 15.

### EXAMPLE 8

The etching rate of the cleaning gas of the present invention was determined in the same manner as in Examples 4 to 6 except that the cleaning gas was changed to a gas having the composition shown in Table 9.

TABLE 9

| | Gas Used and Mixing Ratio | | | |
|---|---|---|---|---|
| | (Volume Ratio) | | | Etching Rate |
| Example | SF₆ | NF₃ | He | (nm/min) |
| 8 | 1 | 1 | 20 | 2,200 |

The etching rate of the cleaning gas of the present invention shown in Example 8 was more excellent than the rate of NF₃ shown in Comparative Example 15.

### EXAMPLES 9 to 11

A testing apparatus shown in FIG. 1 was adjusted to an apparatus inner pressure of 300 Pa. A cleaning gas having the composition shown in Table 10 was excited by a microwave plasma excitation source of 2.45 GHz and 500 W and then introduced into the testing apparatus to etch a silicon wafer placed in the testing apparatus. The etching rate was determined from the loss in volume of the silicon wafer after the etching and the results are shown in Table 10.

TABLE 10

| | Gas Used and Mixing Ratio | | | | |
|---|---|---|---|---|---|
| | (Volume Ratio) | | | | Etching Rate |
| Example | SF₆ | F₂ | O₂ | He | (nm/min) |
| 9 | 1 | 1 | 0.5 | 200 | 300 |
| 10 | 1 | 0.5 | 0.5 | 170 | 260 |
| 11 | 1 | 1.5 | 0.5 | 250 | 290 |

### COMPARATIVE EXAMPLE 16 to 18

The etching rate of the cleaning gas of the present invention was determined in the same manner as in Examples 9 to 11 except that the cleaning gas was changed to a gas having the composition shown in Table 11.

TABLE 11

| | Gas Used and Mixing Ratio | | | | |
|---|---|---|---|---|---|
| Comparative | (Volume Ratio) | | | | Etching Rate |
| Example | NF₃ | F₂ | O₂ | He | (nm/min) |
| 16 | 1 | 1 | 0.5 | 200 | 170 |
| 17 | 1 | 0.5 | 0.5 | 170 | 160 |
| 18 | 1 | 1.5 | 0.5 | 250 | 160 |

All of the etching rate of the mixed gases shown in Comparative Examples 16 to 18 were lower than the rate of the cleaning gases of the present invention shown in Examples 9 to 11.

### EXAMPLE 12

The etching rate of the cleaning gas of the present invention was determined in the same manner as in Examples 9 to 11 except that the cleaning gas was changed to a gas having the composition shown in Table 12.

TABLE 12

| | Gas Used and Mixing Ratio | | | | |
|---|---|---|---|---|---|
| | (Volume Ratio) | | | | Etching Rate |
| Example | SF₆ | F₂ | O₂ | He | (nm/min) |
| 12 | 1 | 1 | 0.5 | 20 | 3,000 |

The etching rate of the cleaning gas of the present invention shown in Example 12 was more excellent than the rate of NF₃ shown in Comparative Example 15.

### EXAMPLE 13

In place of a silicon water, a quartz piece having accumulated thereon deposits of amorphous silicon, silicon nitride and the like was used for the cleaning. The cleaning gas used in Example 1 was excited by a microwave plasma excitation source of 2.45 GHz and 500 W and introduced into a chamber of a testing apparatus adjusted to an inner pressure of 300 Pa, and the quartz piece was cleaned and then taken out. As a result, it was confirmed that deposits were completely removed.

### EXAMPLE 14

In place of a silicon wafer, a quartz piece having accumulated thereon deposits of amorphous silicon, silicon nitride and the like was used for the cleaning. The cleaning gas used in Example 4 was excited by a microwave plasma excitation source of 2.45 GHz and 500 W and introduced into a chamber of a testing apparatus adjusted to an inner pressure of 300 Pa, and the quartz piece was cleaned and then taken out. As a result, it was confirmed that deposits were completely removed.

### EXAMPLE 15

In place of a silicon wafer, a quartz piece having accumulated thereon deposits of amorphous silicon, silicon nitride and the like was used for the cleaning. The cleaning gas used in Example 9 was excited by a microwave plasma excitation source of 2.45 GHz and 500 W and introduced into a chamber of a testing apparatus adjusted to an inner pressure of 300 Pa, and the quartz piece was cleaned and then taken out. As a result, it was confirmed that deposits were completely removed.

### INDUSTRIAL APPLICABILITY

The cleaning gas for semiconductor production equipment of the present invention is high in the etching rate, therefore, ensures efficient cleaning and excellent cost performance. According to the method for cleaning semiconductor production equipment of the present invention, unnecessary deposits in the film-forming equipment or etching equipment for the production of a semiconductor or a TFT liquid crystal element accumulated at the film-formation or etching of silicon, silicon nitride, silicon oxide, tungsten or the like can be efficiently removed. Furthermore, by using the method comprising a cleaning step of using the cleaning gas of the present invention and a step of decomposing and thereby rendering harmless the fluorocompound-containing exhaust gas discharged from the cleaning step, a semiconductor device can be efficiently produced.

1. A cleaning gas for semiconductor production equipment, which is a cleaning gas for removing deposits in the equipment, comprising an inert gas and at least two gases selected from the group consisting of SF₆, F₂, and NF₃ excluding the combination of F₂ and NF₃ alone.

2. The cleaning gas for semiconductor production equipment as described in claim 1, comprising SF₆, F₂, and an inert gas.

3. The cleaning gas for semiconductor production equipment as described in claim 1, comprising SF₆, NF₃, and an inert gas.

4. The cleaning gas for semiconductor production equipment as described in claim 1, comprising SF₆, F₂, NF₃, and an inert gas.

5. The cleaning gas for semiconductor production equipment as described in any one of claims 1 to 4, wherein the inert gas is at least one selected from the group consisting of He, Ne, Ar, Xe, Kr and N₂.

6. The cleaning gas for semiconductor production equipment as described in claim 5, wherein the inert gas is at least one selected from the group consisting of He, Ar, and N₂.

7. The cleaning gas for semiconductor production equipment as described in claim 1, wherein F₂ and/or NF₃ is from 0.01 to 5 and the inert gas is from 0.01 to 500 in terms of the volume ratio assuming that SF₆ is 1.

8. The cleaning gas for semiconductor production equipment as described in claim 7, wherein F₂ and/or NF₃ is from 0.1 to 1.5 and the inert gas is from 0.1 to 30 in terms of the volume ratio assuming that SF₆ is 1.

9. The cleaning gas for semiconductor production equipment as described in claim 1, which contains at least one gas selected from the group consisting of perfluorocarbon, hydrofluorocarbon, perfluoroether and hydrofluoroether.

10. The cleaning gas for semiconductor production equipment as described in claim 9, wherein the perfluorocarbon and hydrofluorocarbon each has from 1 to 4 carbon atoms and the perfluoroether and hydrofluoroether each has from 2 to 4 carbon atoms.

11. A cleaning gas for semiconductor production equipment, which is a gas for removing deposits in the equipment, comprising an oxygen-containing gas, an inert gas and at least two gases selected from the group consisting of SF₆, F₂, and NF₃ excluding the combination of F₂ and NF₃ alone.

12. The cleaning gas for semiconductor production equipment as described in claim 11, comprising an oxygen-containing gas, an inert gas, SF₆, and F₂.

13. The cleaning gas for semiconductor production equipment as described in claim 11, comprising an oxygen-containing gas, an inert gas, SF₆, and NF₃.

14. The cleaning gas for semiconductor production equipment as described in claim 11, comprising an oxygen-containing gas, an inert gas, SF₆, F₂ and NF₃.

15. The cleaning gas for semiconductor production equipment as described in any one of claims 11 to 14, wherein the oxygen-containing gas is at least one selected from the group consisting of O₂, O₃, N₂O, NO, NO₂ CO and CO₂.

16. The cleaning gas for semiconductor production equipment as described in claim 15, wherein the oxygen-containing gas is O₂ and/or N₂O.

17. The cleaning gas for semiconductor production equipment as described in any one of claims 11 to 14, wherein the inert gas is at least one selected from the group consisting of He, Ne, Ar, Xe, Kr and N₂.

18. The cleaning gas for semiconductor production equipment as described in claim 17, wherein the inert gas is at least one selected from the group consisting of He, Ar, and N₂.

19. The cleaning gas for semiconductor production equipment as described in claim 11, wherein F₂ and/or NF₃ is from 0.01 to 5, the oxygen-containing gas is from 0.01 to 5 and the inert gas is from 0.01 to 500 in terms of the volume ratio assuming that SF₆ is 1.

20. The cleaning gas for semiconductor production equipment as described in claim 19, wherein F₂ and/or NF₃ is from 0.1 to 1.5, the oxygen-containing gas is from 0.1 to 1.5 and the inert gas is from 0.1 to 30 in terms of the volume ratio assuming that SF₆ is 1.

21. The cleaning gas for semiconductor production equipment as described in claim 11, which contains at least one gas selected from the group consisting of perfluorocarbon, hydrofluorocarbon, perfluoroether and hydrofluoroether.

22. The cleaning gas for semiconductor production equipment as described in claim 21, wherein the perfluorocarbon and hydrofluorocarbon each has from 1 to 4 carbon atoms and the perfluoroether and hydrofluoroether each has from 2 to 4 carbon atoms.

23. A method for cleaning semiconductor production equipment, comprising use of the cleaning gas described in any one of claims 1 to 10.

24. The method for cleaning semiconductor production equipment as described in claim 23, wherein the cleaning gas described in any one of claims 1 to 10 is excited to produce plasma and the deposits in the semiconductor production equipment are removed in the plasma.

25. The method for cleaning semiconductor production equipment as described in claim 24, wherein the excitation source for the plasma is a microwave.

26. The method for cleaning semiconductor production equipment as described in any one of claims 23 to 25, wherein the cleaning gas described in any one of claims 1 to 10 is used at a temperature range of 50 to 500° C.

27. The method for cleaning semiconductor production equipment as described in claim 23, wherein the cleaning gas described in any one of claims 1 to 10 is used at a temperature range of 200 to 500° C. in a plasmaless system.

28. A method for cleaning semiconductor production equipment, comprising use of the cleaning gas described in any one of claims 11 to 22.

29. The method for cleaning semiconductor production equipment as described in claim 28, wherein the cleaning gas described in any one of claims 11 to 22 is excited to produce plasma and the deposits in the semiconductor production equipment are removed in the plasma.

30. The method for cleaning semiconductor production equipment as described in claim 29, wherein the excitation source for the plasma is a microwave

31. The method for cleaning semiconductor production equipment as described in any one of claims 28 to 30, wherein the cleaning gas described in any one of claims 11 to 22 is used at a temperature range of 50 to 500° C.

32. The method for cleaning semiconductor production equipment as described in claim 28, wherein the cleaning gas described in any one of claims 11 to 22 is used at a temperature range of 200 to 500° C. in a plasmaless system.

33. A method for producing a semiconductor device, comprising a cleaning step of using a cleaning gas containing an inert gas and at least two gases selected from the group consisting of SF₆, F₂ and NF₃ excluding the combination of F₂ and NF₃ alone, and a decomposition step of decomposing a fluorocompound-containing gas discharged from the cleaning step.

34. The method for producing a semiconductor device as described in claim 33, wherein the fluorocompound is at least one compound selected from the group consisting of HF, SiF₄, SF₆, SF₄, SOF₂, SO₂F₂, and WF₆.

35. A method for producing a semiconductor device, comprising a cleaning step of using a cleaning gas containing an inert gas, an oxygen-containing gas and at least two gases selected from the group consisting of SF₆, NF₃ and F₂ excluding the combination of F₂ and NF₃ alone, and a decomposition step of decomposing a fluorocompound-containing gas discharged from the cleaning step.

36. The method for producing a semiconductor device as described in claim 35, wherein the fluorocompound is at least one compound selected from the group consisting of HF, SiF₄, SF₆, SF₄, SOF₂, SO₂F₂, and WF₆.
